(19) United States
(12) Patent Application Publication
(10) Pub. No.: US 2007/0022233 A1
(43) Pub. Date: Jan. 25, 2007

(54) Document processing device with USB drive

(75) Inventors: Amanda Kay Bridges, Winchester, KY (US); William James Gardner Flowers, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/185,286

(22) Filed: Jul. 20, 2005

(51) Int. Cl. G06F 13/38

(52) U.S. Cl. 710/62

(57) ABSTRACT

A printing device operable to perform a plurality of document processing functions. The printing device includes a housing, a USB port positioned on the housing, a user interface and a controller. The USB port is configured to receive a portable data storage device having memory for storing data. The user interface includes a display and is operable to display a plurality of user controls. Each user control is associated with one of the plurality of document processing functions. The controller is coupled to the USB port and the user interface. The controller is operable to parse the memory of the portable data storage device for data stored in the memory when the portable storage device is inserted into the USB port. The controller is also operable to display data stored in the memory on the display of the user interface and is operable to display the user controls associated with the document processing functions that can be performed on the data being displayed.

### BACKGROUND

The present invention relates to document processing devices and, more particularly, to document processing devices capable of perform various functions.

### SUMMARY

In one embodiment, the invention provides a printing device operable to perform a plurality of document processing functions. The printing device includes a housing, a USB port positioned on the housing, a user interface and a controller. The USB port is configured to receive a portable data storage device having memory for storing data. The user interface includes a display and is operable to display a plurality of user controls. Each user control is associated with one of the plurality of document processing functions. The controller is coupled to the USB port and the user interface. The controller is operable to parse the memory of the portable data storage device for data stored in the memory when the portable storage device is inserted into the USB port. The controller is also operable to display data stored in the memory on the display of the user interface and is operable to display the user controls associated with the document processing functions that can be performed on the data being displayed.

In another embodiment, the invention provides a printing device operable to perform a document processing function. The printing device includes a housing, a USB port positioned on the housing, and a controller. The USB port is configured to receive a portable data storage device having memory for storing data. The controller is coupled to the USB port and is operable to parse the memory of the portable data storage device for data stored in the memory when the portable storage device is inserted into the USB port. The controller parses the memory of the portable data storage device for data that can be processed by the document processing function.

In another embodiment, the invention provides a method of retrieving and processing files by a multi-function printer operable to perform a plurality of document processing functions. The method includes the steps of inserting a portable data storage device having a memory into a USB port included in the multi-function printer and parsing the memory of the portable data storage device for files stored in the memory. The method also includes the steps of displaying the files stored in the memory on a user interface of the multi-function printer, selecting a file to be processed by a document processing function of the multi-function print, and performing the document processing function selected.

Other aspects of the invention will become apparent by consideration of the detailed description and accompanying drawings.

### BRIEF DESCRIPTION OF THE DRAWINGS

FIG. 1 is a schematic illustration of a document processing device.

FIG. 2 is another schematic illustration of a document processing device.

FIG. 3 is a perspective view of a portable data storage device for use with a device, such as the document processing devices illustrated in FIGS. 1 and 2.

FIG. 4 illustrates a first screen displayed by a user interface of device, such as the document processing devices illustrated in FIGS. 1 and 2.

FIG. 5 illustrates a second screen displayed by a user interface of a device, such as the document processing devices illustrated in FIGS. 1 and 2.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

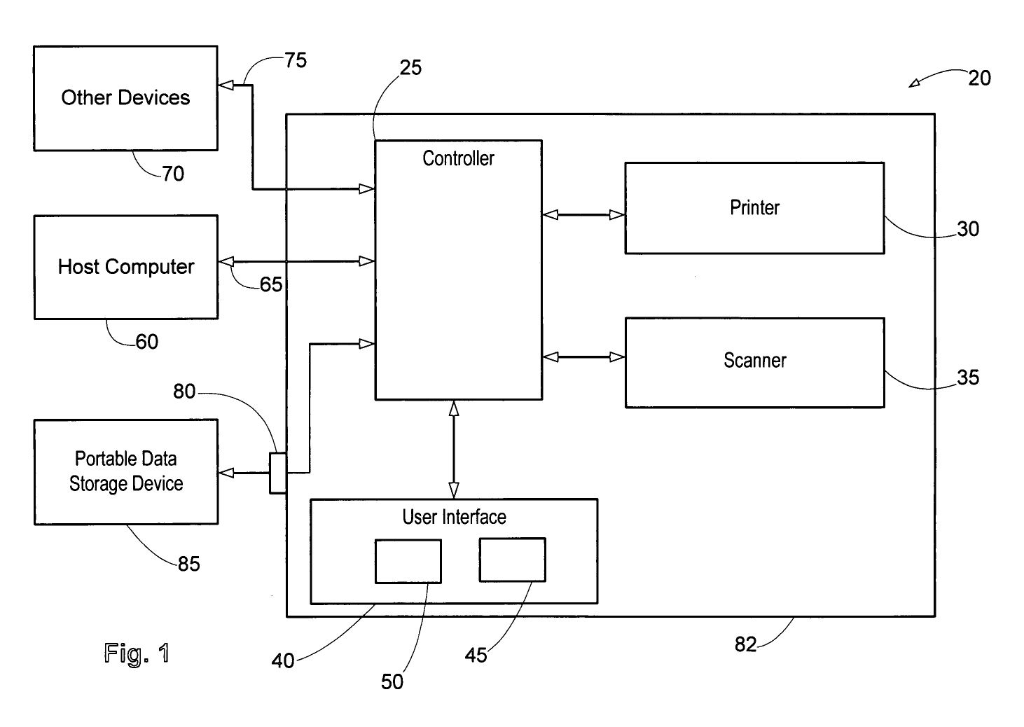

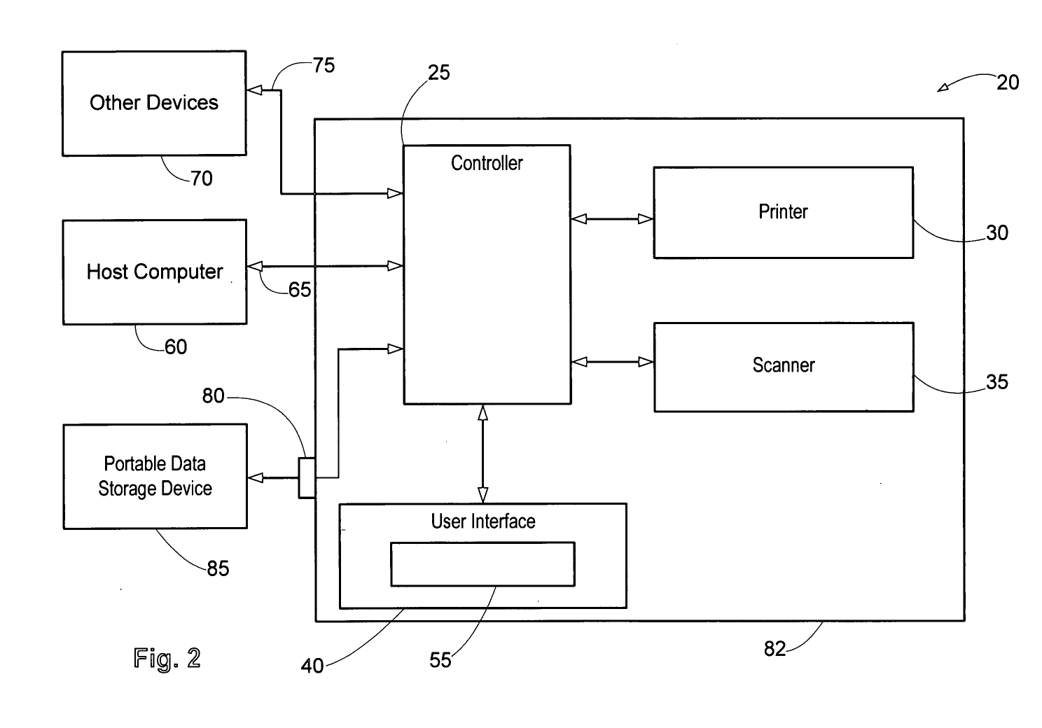

FIGS. 1 and 2 each schematically show a device 20 capable of performing one or several related tasks in the area of scanning, printing, duplicating and/or faxing documents. In some embodiments, the device 20 can be a multi-function printer (“MFP”) that can perform several processing functions, such as, for example, printing, scanning, electronic mailing, faxing, duplicating and other various functions. In other embodiments of the invention, the device 20 can be limited to a single document processing function, such as, for example, printing, scanning, duplicating or other related functions. For example, the device 20 can be a printer, a scanner, a copy machine or the like. In the construction shown in FIGS. 1 and 2, the device 20 is an MFP.

As shown in FIGS. 1 and 2, the MFP 20 includes a controller 25. In the illustrated construction, the controller 25 monitors operation of the MFP 20 and controls the various functions of MFP 20, such as printing, scanning, duplicating and the like. The controller 25 also communicates with various document processing modules included in the MFP 20, such as, for example, a printer 30 and a scanner 35. The controller 25 also communicates with various devices external to the MFP 20, as discussed below. The controller 25 can also format and handle files to be sent via e-mail.

As mentioned previously, in some constructions, the MFP 20 includes various document processing modules, such as the printer 30 and the scanner 35. The printer 30 is operable to receive electronic data representing a desired image from the controller 25. The printer 30 is also operable to print a hard copy of that desired image on a print medium, such as a sheet of paper (not shown). For example, the printer 30 communicates with the controller 25, and can receive electronic data in a printer format from the controller 25 and instructions that cause the printer to print in a desired manner, as is known in the art.

The scanner 35 includes a scanning area (not shown) on which an original can be placed either manually or automatically by being sequentially fed from a storage unit (not shown) under the control of the controller 25. For example, if the original includes multiple pages, an automatic feeder function (not shown) of the device 20 sequentially feeds the pages to the scanning area. Different types of scanners are known in the art and include different sensors for producing scanned image data. An illumination system (not shown) provides proper light such that the sensors can obtain accurate readings of the original. The scanned image data represents the original. The controller 25 is also operable to convert scanned image data from the scanner 35 into electronic data in the printer format.

In some constructions, the MFP 20 can also perform optical character recognition. In these constructions, the controller 25 of the MFP 20 can convert scanned image data into electronic data in a printer format. For example, the controller 25 may receive scanned image data in the form of a PDF file. The controller 25 then converts the PDF file into electronic data in printer format, such as a text file, using optical character recognition.

In the constructions shown, the MFP 20 can also include a user interface 40. The user interface 40 can allow a user to control and monitor the various document processing functions. The user interface 40 includes at least one user control 45 to prompt the device 20 to perform a function or to modify a particular function. In some constructions, the user control 45 includes one or more push buttons. In other constructions, the user control 45 includes a keypad. In further constructions, such as the construction shown in FIG. 2, the user control 45 includes a touch-screen 55.

In the construction illustrated in FIG. 1, the user interface 40 can also include a display 50. The display 50 can relate information to the user through various menus and screens, as discussed below. In some constructions, such as the construction illustrated in FIG. 1, the display 50 is separate from the user control 45. In other constructions, the display 50 (FIG. 1) can be combined with the user control 45 (FIG. 1). For example, as shown in FIG. 2, the user interface 40 can include the touch screen 55. In this construction, the touch screen 55 includes both the user control 45 of FIG. 1 and the display 50 of FIG. 1.

In the illustrated construction, the controller 25 is operable to communicate with the various document processing modules, such as the printer 30 and the scanner 35, and is also operable to communicate with one or more secondary devices. For example, as shown in FIGS. 1 and 2, the controller 25 can communicate with a host computer 60. The host computer 60 can send information (such as, for example, electronic data in a printer format), commands, code and the like to the controller 25 of the MFP 20, and in turn, the controller 25 can also send information to the host computer 60. Communication can take place between the controller 25 and the host computer 60 via a first link 65. In some constructions, the link 65 can include a network, such as a wireless network, a wired network or a combination of both. In other constructions, the link 55 can be a phone line, a serial cable or another similar wired or wireless link.

The controller 25 can also be operable to communicate with other devices 70, such as, for example additional computers, servers or the like included in a network, personal digital assistants, additional document processing device, such as, scanners, printers and MFPs, or the like. The controller 25 can communicate with the other devices 70 via a second link 75. In some constructions, the second link 75 can also be the same network which links the MFP 20 with the host computer 60 or can be a similar link as the first link 65. In other constructions, the second link 75 can be a different link from the first link 65, such as, for example, a wireless network, a wired network, combination of both, a phone line, a serial cable or another similar wired or wireless link.

In the illustrated construction, the MFP 20 also includes a USB port 80. In some constructions, the USB port 80 can be positioned on a front face (not shown) of the housing 82 of the MFP 20 (shown schematically in FIGS. 1 and 2). For example, the USB port 80 can be positioned on the housing 82 close to the user interface 40. In other constructions, the USB port 80 can be positioned elsewhere on the housing 82.

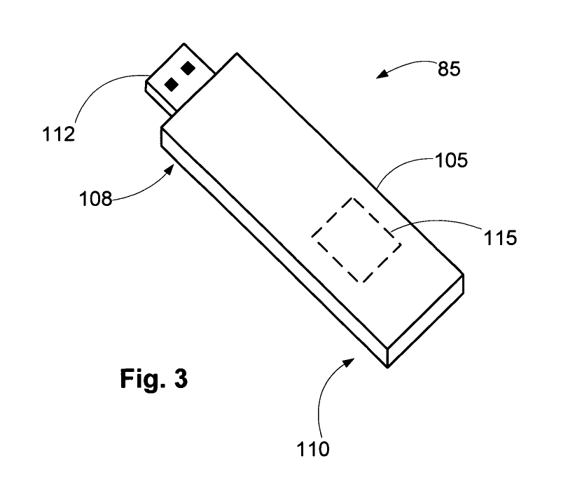

The USB port 80 is configured to connect to a portable data storage device 85 (shown schematically in FIGS. 1 and 2 and also shown in FIG. 3). The controller 25 is also operable to communicate with a portable data storage device 85, when the portable data storage device 85 connects to the USB port 80.

As shown in FIG. 3, the portable data storage device 85 includes a housing 105 having a first end 108 and a second end 110. The portable data storage device 85 also includes a USB connector 112 positioned on the housing 105, such as, for example, on the first end 108 of the housing 105. The USB connector 112 is configured to connect with the USB port 80 of the MFP 20.

The portable data storage device 85 also includes memory 115 substantially enclosed within the housing 105. In some constructions, the memory 115 includes non-volatile memory, such as, for example, EEPROM memory. The storage device 85 can include other types of non-volatile memory, as is know in the art.

As shown schematically in FIGS. 1 and 2 and mentioned previously, the controller 25 is also operable to communicate with the portable data storage device 85 and to retrieve data stored within the memory 115 of the portable data storage device 85, when the storage device 85 is connected to the USB port 80. For example, upon insertion, the controller 25 can automatically parse the memory 115 of the storage device 85 for various files and can also automatically retrieve files from the memory 115.

In some constructions, when the storage device 85 is inserted in the USB port 80, the controller 25 can automatically recognize the connection and begin to parse the memory 115 of the storage device 85. In these constructions, the controller 25 may automatically display a screen on the user interface 40 in response to the insertion of the storage device 85, as discussed below. In other constructions, the controller 25 may need to be prompted to parse the memory 115 of the storage device 85. In these constructions, the prompt to parse the storage device 85 may originate from the host computer 60, one of the other devices 70, or from a user via the one or more user controls 45.

In some constructions, the controller 25 parses the memory 115 of the storage device 85 for files that fall into a category of functions that can be handled by the device 20 (e.g., MFP 20). For example, the controller 25 of an device 20 may parse the memory 115 for specific types of files, such as Word documents or PDF documents, that can either be printed, e-mailed or processed according to one of the document processing functions of the MFP 20. In other constructions, the controller 25 may parse the entire memory 115 of the storage device for all files, regardless if the files can be processed by the device 20.

In further constructions, the controller 25 may parse only a designated portion of the memory 115 of the storage device 85. According to these constructions, the controller 25 can parse the designated portion of the memory 115 for specific files, such as those files which can be processed by one or more document processing functions of the device 20, or can parse the portion of the memory 115 for all files, regardless if the device 20 can open and/or process those files. In another example, the controller 25 may parse only a portion of the memory 115 for a specific file, such as updated software (e.g., a code load).

Once the controller 25 parses all or a portion of the memory 115 of the storage device 85, the controller can automatically retrieve certain files stored within the memory 115. In some constructions, the controller 25 can retrieve a certain file (e.g. a file including data representing a desired image) based on a prompt from one of the host computer 60, another device 70 or a user via the user controls 45. The controller 25 can transmit the data included in the file to one of the document processing modules, such as, for example, the printer 30, based on the prompt received. The controller 25 can also manipulate the data according to the received prompt. In other constructions, the controller 25 can automatically process a certain file stored in the memory 115 (such as, for example, transmit to one of the document processing modules, manipulate the data, convert the data to another format, open the file, etc.) based on one or more settings stored in the controller 25 or based on previous commands or prompts received by the controller 25.

In some constructions, the controller 25 can change the screen displayed on the user interface 40 to acknowledge when a storage device 85 has been inserted into the USB port 80. For example, in one construction, the controller 25 automatically changes the screen displayed when the controller 25 identifies that a storage device 85 has been inserted and connected to the USB port 80. In this construction, for example, the screen can indicate to a user that a storage device 85 has been inserted into the USB port 80. The screen can also indicate to a user that the controller 25 is currently establishing a connection with the storage device 85 and/or is reading the memory 115 of the storage device 85. In another construction, for example, the controller 25 automatically changes the screen displayed once the controller 25 parses at least a portion of the memory 115 of the storage device 85. In this construction, the amount of memory 115 the controller 25 parses determines the amount of time elapsed before the controller 25 changes the display screen. In a further construction, the controller 25 changes the screen displayed once the controller 25 receives a command to do so, such as, for example, a prompt from the host computer 60, another device 70 or a user via the user controls 45.

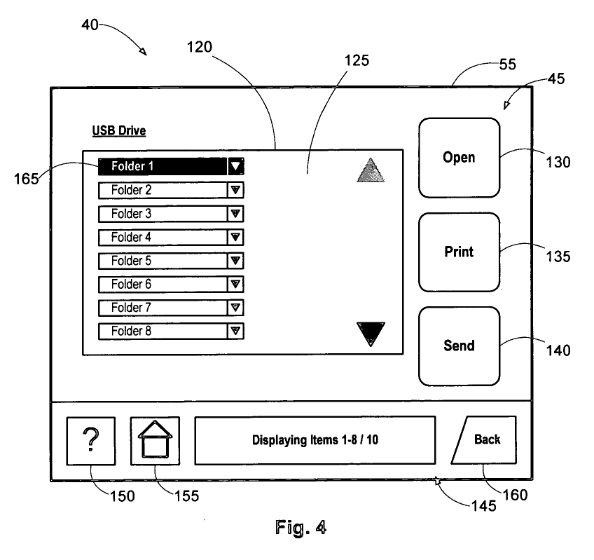

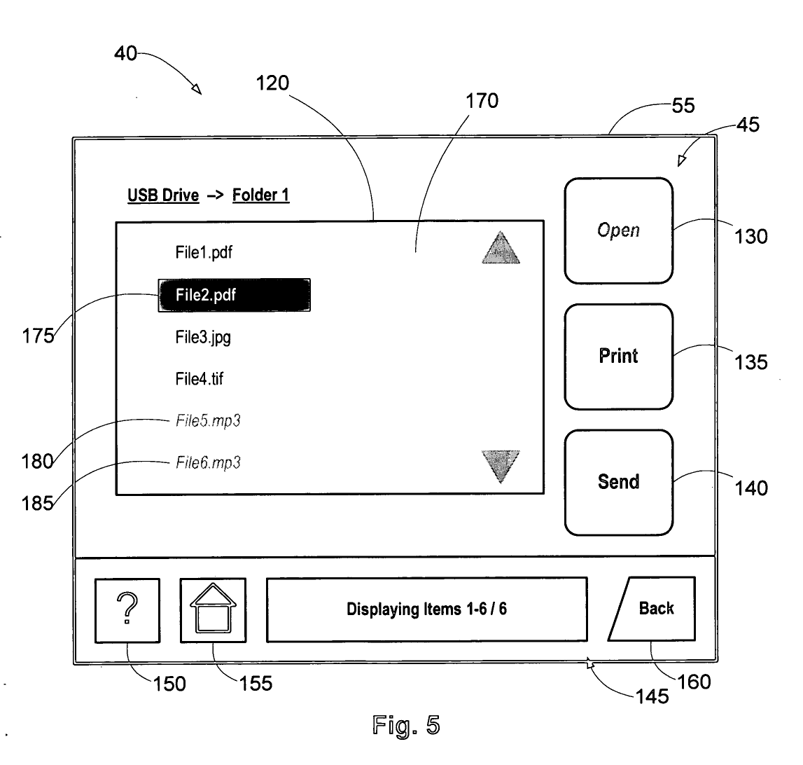

One example of the screen displayed on the user interface 40 (that acknowledges when a storage device 85 has been inserted into the USB port 80) is shown in FIGS. 4 and 5. In these constructions, the controller 25 parses the entire memory 115 of the storage device 85 for all files, regardless if the device 20 can open and/or process those files or not. In other constructions, the controller 25 may only parse a portion of the memory 115 and/or may only parse the memory 115 for particular types of files.

As shown in FIG. 4, the user interface 40 includes a main window 120 which the controller 25 uses to display various screens once the controller 25 parses the memory 115 of the storage device 85. In this construction, the user interface 40 is a touch-screen which includes both the display 50 and the user controls 45 (as mentioned previously with respect to FIGS. 1 and 2). The main window 120 can be used by the controller 25 to display information to a user, such as, for example, the contents of the memory 115. As shown in FIG. 4, the main window 120 includes a screen 125 depicting the first level of items (e.g., various folders) being stored in the memory 115 of the storage device 85. The main window 120 can also be used by the controller 25 to display the contents of a selected file.

In some constructions, the user interface 120 also includes various user controls 45. The user controls 45 can be associated with various document processing functions that the MFP 20 can perform. In some constructions, the controller 25 displays only those user controls 45 associated with the document processing functions that can be performed on selected files. For example, for a file containing electronic data in printer format, such as a text file, the controller 25 may display user controls 45 associated with printing and emailing. In this construction, the controller 25 may not display a user control 45 associated with optical character recognition, since the file already contains data in printer format. In other constructions, the controller 25 can display all the user controls 45 associated with all the functions that the MFP 20 can perform. In these constructions, the controller 45 may display the functions in a manner that indicates to a user which functions can be performed for the selected file.

In the illustrated construction, the user controls 45 include an open control 130, a print control 135 and a send control 140. In some constructions, the open control 130 can open a particular file and display the data on the main window 120. In other constructions, the open control 130 can open a folder, such as the construction illustrated in FIGS. 4 and 5. The print control 135 can prompt the controller 25 to send the data included in a selected file to the printer 30. Similarly, the send control 140 can prompt the controller 25 to send the file to another device, e-mail address or IP address. In other constructions, the device 20 can include more or fewer user controls 45 that shown and described, such as, for example, a control to perform optical character recognition for files relating to scanned image data.

Also as shown, the user interface 40 can also include a navigation window 145. The navigation window 145 can include additional user controls to allow a user to navigate through various screens displayed on the main window 120. For example, in the construction shown, the navigation window 145 can include a help control 150, a home control 155 and a previous screen control 160. The help control 150 prompts the controller 25 to display the help screen (not shown) on the main window 120. The home control 155 prompts the controller 25 to display the home screen. In one example, the screen 120 shown in FIG. 4, which depicts the first level of items stored in the memory 115 of the storage device 85, is the home screen. The previous screen control 160 prompts the controller 25 to display the screen that was previously displayed on the main window 120.

As shown in FIG. 4, the first level of items stored in the memory 115 include various folders. The folders are displayed on the main window 120 by the controller 25 in the first screen 125. A user can select a folder, such as the first folder 160, by highlighting the folder via the touch-screen 55. Selecting a folder, such as the first folder 160, and prompting the controller 25 to open that folder via the open control 130, also prompts the controller 25 to display the items stored under that folder on the main window 120 in another screen, such as the second screen 170 (shown in FIG. 5).

In the construction shown in FIG. 5, the controller 25 parsed the memory 115 of the storage device 85 for all files and displayed all the files stored under the selected folder in the second screen 170. The files that the device 20 can process, such as file 175, are displayed on the screen 20 in a manner which indicates that they can be manipulated (such as, for example, can be highlighted by a user, selected by a user, are displayed in bold and/or black, etc.). The files that the device 20 can not process, such as files 180 and 185, are displayed on the screen 20 in a manner which indicates that those files can not be manipulated (such as, for example, can not be highlighted by a user, can not be selected by a user, are displayed in grey and/or italics, etc.). In other constructions, the controller 25 can only display those files, such as file 175, that can be processed by the device 20.

As shown in FIG. 5, a user can select a file, such as file 175, and prompt the device to process that file according to one of the available user controls 45. For example, in the construction shown, the file 175 can be printed by the printer 30 via the print control 135 or can be sent in an e-mail via the send control 140. As mentioned previously, the device 20 can include more or fewer user controls 45 than shown and described.

Thus, the invention provides, among other things, a document processing device having a USB port. Various features and advantages of the invention are set forth in the following claims.

What is claimed is:

1. A printing device operable to perform a plurality of document processing functions, the printing device comprising:
a housing;
a USB port positioned on the housing, the USB port configured to receive a portable data storage device having memory for storing data;
a user interface having a display and operable to display a plurality of user controls, each user control being associated with one of the plurality of document processing functions; and
a controller coupled to the USB port and the user interface, the controller operable to parse the memory of the portable data storage device for data stored in the memory when the portable storage device is inserted into the USB port, the controller also operable to display data stored in the memory on the display of the user interface and operable to display the user controls associated with the document processing functions that can be performed on the data being displayed.

2. The printing device as set forth in claim 1 and wherein the controller is also configured to retrieve data stored within the memory of the portable data storage device when the portable data storage device is inserted into the USB port.

3. The printing device as set forth in claim 3 and further comprising a printer coupled to the controller, the printer being operable to receive data representing an image from the controller and operable to print a hard copy of the image.

4. The printing device as set forth in claim 3 and wherein the data retrieved from the memory of the portable data storage device by the controller includes the data representing the image.

5. The printing device as set forth in claim 1 and wherein the controller is operable to parse the memory of the portable data storage device for data that can be processed by one of the plurality of document processing functions.

6. The printing device as set forth in claim 5 and wherein the controller is further operable to display all data that can be processed by one of the plurality of document processing functions on the user interface.

7. The printing device as set forth in claim 1 and wherein the controller is operable to parse the memory of the portable data storage device for data that can be processed by one of the plurality of document processing functions and for data that can not be processed by any of the plurality of document processing functions.

8. The printing device as set forth in claim 7 and wherein the controller is further operable to display only the data that can be processed by one of the plurality of document processing functions on the user interface.

9. The printing device as set forth in claim 7 and wherein the controller is further operable to display the data that can be processed by one of plurality of document processing functions on the user interface.

10. The printing device as set forth in claim 9 and wherein the controller is further operable to display the data that can not be processed by any of the plurality of document processing functions on the user interface.

11. The printing device as set forth in claim 10 and wherein the controller is further operable to display the data that can not be processed by any of the plurality of document processing functions on the user interface in a manner which indicates to a user that the data can not be processed by the document processing device.

12. The document processing device as set forth in claim 1 and wherein the user interface includes a touch-screen.

13. The document processing device as set forth in claim 1 and wherein the document processing device is a multi-function printer.

14. A printing device operable to perform a document processing function, the printing device comprising:
a housing;
a USB port positioned on the housing, the USB port configured to receive a portable data storage device having memory for storing data;
a controller coupled to the USB port and the user interface, the controller operable to parse the memory of the portable data storage device for data stored in the memory when the portable storage device is inserted into the USB port, wherein the controller parses the memory of the portable data storage device for data that can be processed by the document processing function.

15. The printing device as set forth in claim 14 and further comprising a user interface having a display, and wherein the controller is operable to display the data that can be processed by the document processing function.

16. The printing device as set forth in claim 15 and wherein the controller is operable to display a user control associated with the document processing function on the display.

17. The printing device as set forth in claim 15 and wherein the printing device is operable to perform a plurality of document processing functions.

18. The printing device as set forth in claim 17 and wherein a user can select data on the display and wherein the controller is operable to display a user control associated for each of the document processing functions that can be performed on the selected data.

19. A method of retrieving and processing files by a multi-function printer, the multi-function printer operable to perform a plurality of document processing functions, the method comprising the steps of:
inserting a portable data storage device having a memory into a USB port included in the multi-function printer;
parsing the memory of the portable data storage device for files stored in the memory;
displaying the files stored in the memory on a user interface of the multi-function printer;
selecting a file to be processed by a document processing function of the multi-function print; and
performing the document processing function selected.

20. The method as set forth in claim 19 and wherein the step of parsing the memory of the portable data storage device for files stored in the memory includes parsing the memory of the portable data storage device for files stored in the memory that can be processed by at least one document processing function of the multi-function printer.

21. The method as set forth in claim 20 and wherein the step of displaying the files stored in the memory on a user interface includes displaying the files that can be processed by at least one document processing function of the multi-function printer.

22. The method as set forth in claim 19 and wherein the step of parsing the memory of the portable data storage device for files stored in the memory includes the steps of:
parsing the memory of the portable data storage device for files that can be processed by at least one document processing function of the multi-function printer; and
parsing the memory of the portable data storage device for files that can not be processed by at least one document processing function of the multi-function printer.

23. The method as set forth in claim 22 and wherein the step of displaying the files stored in the memory on a user interface includes the steps of:
displaying the files that can be processed by at least one document processing function of the multi-function printer; and
displaying the files that can not be processed by the at least one document processing function of the multi-function printer.

24. The method as set forth in claim 23 and wherein the step of displaying files that can not be processed by at least one document processing function includes displaying the files that can not be processed by at least one document processing function in a manner which indicates to a user that the data can not be processed by the multi-function printer.
